(19) United States
(12) Patent Application Publication
(10) Pub. No.: US 2013/0254331 A1
(43) Pub. Date: Sep. 26, 2013

(54) INFORMATION PROCESSING APPARATUS, INFORMATION PROCESSING METHOD, PROGRAM, AND INFORMATION PROCESSING SYSTEM

(71) Applicant: SONY CORPORATION, Tokyo (JP)

(72) Inventors: Masanobu Yamashita, TOKYO (JP); Ko Shikita, SAITAMA (JP); Ko Kobayashi, TOYKO (JP); Fumiaki Suzuki, TOKYO (JP)

(73) Assignee: SONY CORPORATION, Tokyo (JP)

(21) Appl. No.: 13/788,499

(22) Filed: Mar. 7, 2013

(30) Foreign Application Priority Data
Mar. 21, 2012 (JP) 2012-063077

(51) Int. Cl. H04L 29/08

(52) U.S. Cl. CPC H04L 67/10
USPC 709/217

(57) ABSTRACT

An information processing apparatus includes a storage block and a transmission control block. The storage block stores identification information about a device in association with information about a post destination. The transmission control block transmits content which has been sent from the device and which is provided with the identification information to the post destination associated with the identification information. In addition, an information processing method and a program for causing a computer to function as an apparatus include storing identification information about a device in association with information about a post destination, and transmitting content which has been sent from the device and which is provided with the identification information to the post destination associated with the identification information.

### BACKGROUND

The present disclosure relates to an information processing apparatus, an information processing method, a program, and an information processing system. More particularly, the disclosure relates to an information processing apparatus, an information processing method, a program, and an information processing system for not only assigning services selectively to a plurality of devices but also eliminating the need to perform a selection operation on each of the devices upon selecting the service assigned thereto.

With the widespread use of Internet services such as social media, there have been growing opportunities in recent years for each user to utilize a plurality of services. Whereas many users make selective use of the multiple services they have chosen for specific purposes, the desire exists for each user to utilize the same content in each of these services.

One existing way of meeting that desire is by automatically assigning content to a plurality of services based on the user ID for a given service (e.g., see Japanese Patent Laid-Open No. 2004-234200 referred to as Patent Document 1 herein after).

### SUMMARY

With the spread of camera-equipped portable terminals such as smartphones as well as digital cameras, there are many cases where a single user possesses a plurality of such devices. Under these circumstances, the desire has been recognized for not only assigning services selectively to a plurality of devices but also eliminating the desire to perform a selection operation on each of the devices upon selecting the service assigned thereto. The desire has yet to be met sufficiently by existing methods including that which is disclosed by the above-cited Patent Document 1.

The present disclosure has been made in view of the above circumstances and provides innovative arrangements for assigning services selectively to a plurality of devices while eliminating the need to carry out a selection operation on each of the devices upon selecting the service assigned thereto.

According to one embodiment of the present disclosure, there is provided an information processing apparatus including a storage block and a transmission control block. The storage block may store identification information about a device in association with information about a post destination. The transmission control block may transmit content which has been sent from the device and which is provided with the identification information to the post destination associated with the identification information.

Preferably, the storage block may store the identification information transmitted from either the device or another device used by a user in association with the information about the post destination.

Preferably, the information processing apparatus according to one embodiment of the present disclosure further include a detection block and a query block. The detection block may detect the identification information from the content, and the query block may query whether the identification information detected by the detection block is stored in the storage block so as to acquire from the storage block the information about the post destination associated with the identification information. The transmission control block may transmit the content to the post destination based on the information about the post destination acquired by the query block.

Preferably, the transmission control block may transmit authentication information about the post destination sent from the device to the post destination, and the storage block may store the authentication information if the post destination is successfully authenticated.

Preferably, the identification information may be the serial number of the device.

According to other embodiments of the present disclosure, there are provided an information processing method and a program functionally corresponding to the above-outlined information processing apparatus.

Where the present disclosure is implemented in the form of an information processing apparatus, an information processing method, or a program as outlined in the preceding paragraphs, identification information about a device is stored in association with information about a post destination, and content which has been sent from the device and which is provided with the identification information is transmitted to the post destination associated with the identification information.

According to another embodiment of the present disclosure, there is provided an information processing apparatus including a transmission control block, an acquisition block, and an identification information provision block. The transmission control block may transmit identification information about the information processing apparatus and information about a post destination to which content is to be transmitted. The acquisition block may acquire the content. The identification information provision block may provide the content acquired by the acquisition block with the identification information. The transmission control block may transmit the content provided with the identification information by the identification information provision block to a server in which the information processing apparatus is registered.

According to other embodiments of the present disclosure, there are provided an information processing method and a program functionally corresponding to the information processing apparatus outlined in the immediately preceding paragraph.

Where the present disclosure is implemented in the form of an information processing apparatus, an information processing method, or a program as outlined in the preceding paragraphs, identification information about the information processing apparatus and information about a post destination to which content is to be transmitted are first transmitted. The content is then acquired. The acquired content is provided with the identification information. The content provided with the identification information is transmitted to a server in which the information processing apparatus is registered.

According to further embodiment of the present disclosure, there is provided an information processing system including a user terminal and a server. The user terminal includes: a transmission control block configured to transmit identification information about the user terminal and information about a post destination to which content is to be transmitted; an acquisition block configured to acquire the content, and an identification information provision block configured to provide the content acquired by the acquisition block with the identification information. The transmission control block may transmit the content provided with the identification information by the identification information provision block to a server in which the user terminal is registered. The server includes: a storage block configured to store the identification information in association with the information about the post destination, and a transmission control block configured to transmit the content which has been sent from the user terminal and which is provided with the identification information to the post destination associated with the identification information.

Where the present disclosure is implemented in the form of an information processing system as outlined in the immediately preceding paragraph, a user terminal first transmits identification information about the user terminal as well as information about a post destination to which content is to be transmitted. The content is then acquired. The acquired content is provided with the identification information. The content provided with the identification information is transmitted to a server in which the user terminal is registered. In the server, the identification information is stored in association with the information about the post destination. The content which has been sent from the user terminal and which is provided with the identification information is transmitted to the post destination associated with the identification information.

According to the present disclosure embodied as outlined above, it is possible not only to assign services selectively to a plurality of devices but also eliminate the need to perform a selection operation on each of the devices upon selecting the service assigned thereto.

### BRIEF DESCRIPTION OF THE DRAWINGS

FIG. 1 is a schematic view showing a typical configuration of an information processing system;

FIG. 2 is a block diagram showing another configuration of the information processing system;

FIG. 3 is a block diagram showing a typical hardware structure of a server;

FIG. 4 is a schematic view showing a detailed structure of a user database;

FIG. 5 is a block diagram showing a typical hardware structure of a user terminal;

FIG. 6 is a block diagram showing a typical functional structure of a CPU in the server;

FIG. 7 is a block diagram showing a typical functional structure of the CPU in the user terminal;

FIG. 8 is a block diagram showing how the CPU of the server and that of the user terminal may be structured functionally to implement a user-operated device registration process;

FIG. 9 is a flowchart explaining the flow of the user-operated device registration process;

FIG. 10 is a block diagram showing how the CPU of the server and that of the user terminal may be structured functionally to implement a content posting process;

FIG. 11 is a flowchart explaining the flow of the content posting process;

FIG. 12 is a schematic view showing another typical configuration of the information processing system; and

FIG. 13 is a schematic view showing a further typical configuration of the information processing system.

### DETAILED DESCRIPTION OF THE PREFERRED EMBODIMENT

### [General Description of the Present Technology]

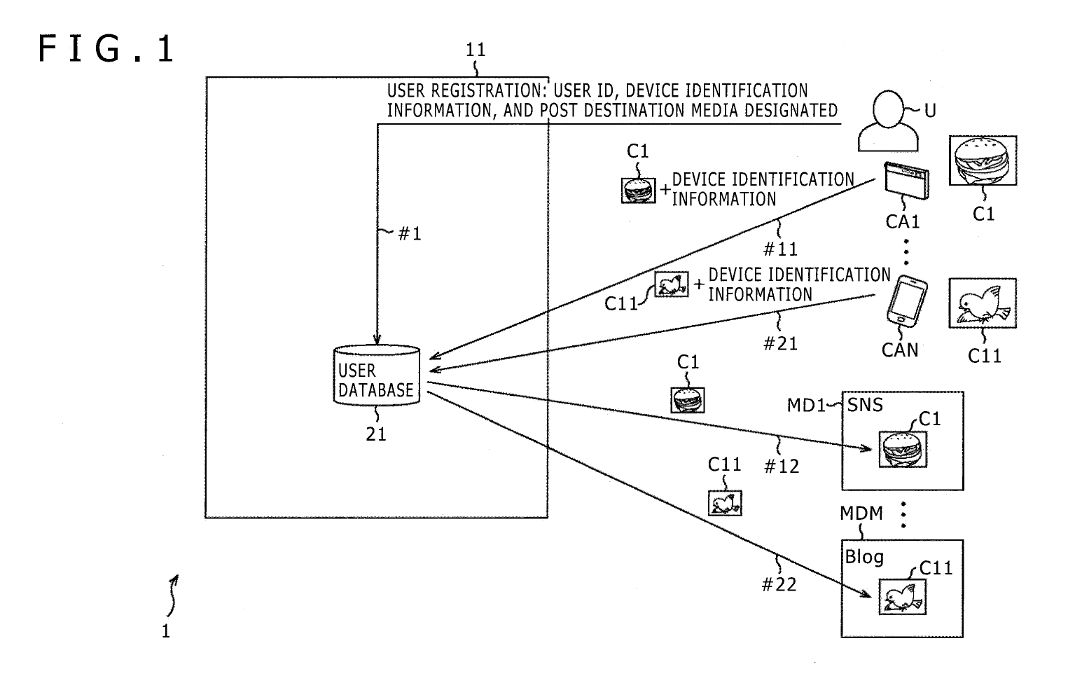

FIG. 1 shows a typical configuration of an information processing system 1 embodying the present disclosure.

In the information processing system 1, a user U possesses a plurality of user terminals CA1 through CAN (N is a desired integer of at least 2). The user terminals CA1 through CAN are made up of diverse terminals having the imaging capability such as a smartphone, a camera-equipped portable terminal and a digital camera. Each of the terminals is provided with uniquely identifiable information (called the device identification information hereunder). For example, the device identification information may be the serial number of each terminal.

The user U can selectively utilize network-based media on each of the user terminals CA1 through CAN to make use of the services offered by the media (called the post destination media hereunder). For example, the media may be social networking services (SNS) such as Facebook or mixi as well as blogs.

Specifically, the user U may utilize the user terminal CA1 to post content to post destination media MD1 acting as SNS. Also, the user U may utilize the user terminal CAN to post content to post destination media MDM serving as a blog.

In order to make such usage of the terminals possible, the user U performs a registration process on a server 11 as follows:

First, as indicated by arrow #1, the user U operates one of the user terminals CA1 through CAN to transmit information that can identify the user U to the server 11 as user information. The user information may include the user ID of the user U, for example. The server 11 possesses a user database 21. Upon receipt of the user information from the user U, the server 11 stores the received user information into the user database 21. This operation completes the user registration.

Next, the user U operates the user terminal CA1 to transmit the device identification information about the user terminal CA1 and information about the post destination media MD1 to the server 11. The user U can also transmit identification information about another user terminal CAk (k is an integer between 2 and N inclusive) apart from the user terminal CA1. The manner in which the user terminal CA1 acquires the device identification information about another user terminal CAk is not limited to any specific technique. For example, the device identification information may be acquired through two-way communication between the terminals. The server 11 stores the device identification information about the user terminal CA1 in association with the information about the post destination media MD1 in the user database 21.

Likewise, the user U operates the user terminal CAN to transmit the device identification information about the user terminal CAN and information about the post destination media MDM to the server 11. The server 11 stores the device identification information about the user terminal CAN in association with the information about the post destination media MDM in the user database 21.

The operations above allow the user U to, say, selectively post content to the post destination media MD1 using the user terminal CA1 and post content to the post destination media MDM using the user terminal CAN.

For example, the user U may generate content of images and/or sounds (called user-generated content or UGC hereunder where appropriate) using the user terminal CA1 and post the content onto the network. The posted content may then be reproduced on the post destination media MD1. The user U may also generate UGC using the user terminal CAN and post the UGC onto the network. The UGC may then be reproduced on the post destination media MDM. Although the UGC may include not only images but also sounds as mentioned above, the UGC will be handled as images in the ensuing description for purpose of simplification and illustration.

Specifically, suppose that the user U takes an image of a hamburger using the user terminal CA1 to generate the image of the hamburger as content C1. In this case, the user terminal CA1 provides the generated content C1 with the device identification information about the user terminal CA1. The user terminal CA1 transmits the content C1 provided with the device identification information about the user terminal CA1 to the server 11 as indicated by arrow #11.

Upon receipt of the content C1, the server 11 detects the device identification information attached to the content C1. The server 11 then queries whether the detected device identification information is registered in the user database 21. Since the device identification information about the user terminal CA1 has already been registered in the user database 21, the server 11 acquires the information about the post destination media MD1 associated with the registered device identification information.

Based on the acquired information about the post destination media MD1, the server 11 transmits the content C1 to a server that manages the post destination media MD1 (the latter server will be called the media management server hereunder) as indicated by arrow #12. Thereafter, the content C1 is shared with other users on the post destination media MD1.

Meanwhile, suppose that the user U takes an image of a bird using the user terminal CAN to generate the image of the bird as content C11. In this case, the user terminal CAN provides the generated content C11 with the device identification information about the user terminal CAN. The user terminal CAN transmits the content C11 provided with the device identification information about the user terminal CAN to the server 11 as indicated by arrow #21.

Upon receipt of the content C11, the server 11 detects the device identification information attached to the content C11. The server 11 then queries whether the detected device identification information is registered in the user database 21. Since the device identification information about the user terminal CAN has already been registered in the user database 21, the server 11 acquires the information about the post destination media MDM associated with the registered device identification information.

Based on the acquired information about the post destination media MDM, the server 11 transmits the content C11 to a media management server that manages the post destination media MD2 as indicated by arrow #22. Thereafter, the content C11 is shared with other users on the post destination media MDM.

In the information processing system 1, as explained above, the user registers in the server 11 the device identification information about each of the user terminals in association with the post destination media to be used by the user terminal in advance. When the user generates content on a given user terminal, the content is provided with the device identification information about the user terminal in question before being transmitted to the server 11. In turn, the server 11 can identify the post destination media associated with the user terminal based on its device identification information and transfer the content to the identified post destination media.

In this manner, the user can not only make selective use of different services on each of a plurality of user terminals but also dispense with selection operations on a given user terminal upon selectively using the service assigned to that terminal.

### [Typical Configuration of the Information Processing System]

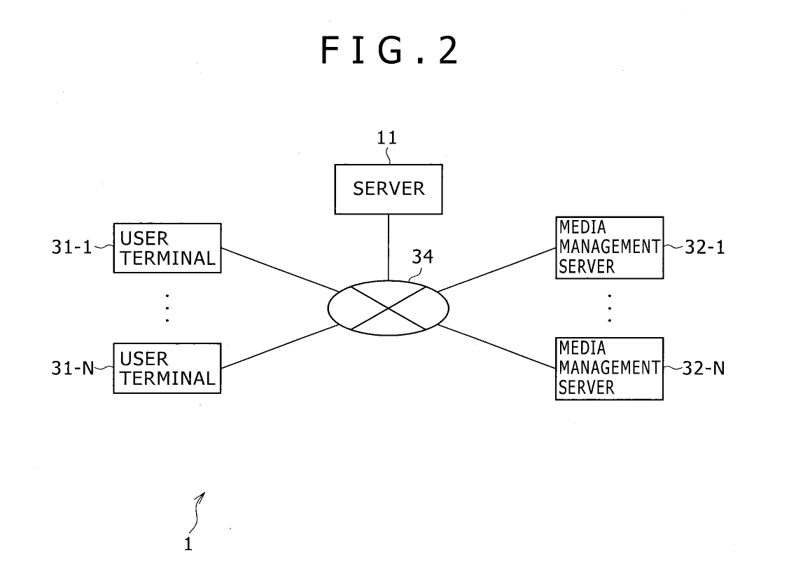

FIG. 2 is a block diagram showing a configuration of the information processing system 1.

The information processing system 1 is made up of a server 11, user terminals 31-1 through 31-N (N is an integer of at least 1), and media management servers 32-1 through 32-M (M is an integer of at least 1) interconnected with one another via a network 34. In the ensuing description, the user terminals 31-1 through 31-N will be generically referred to as the user terminal 31 and the media management servers 32-1 through 32-M as the media management server 32 if there is no need to distinguish the individual terminals or servers from one another.

### [Typical Hardware Structure of the Server]

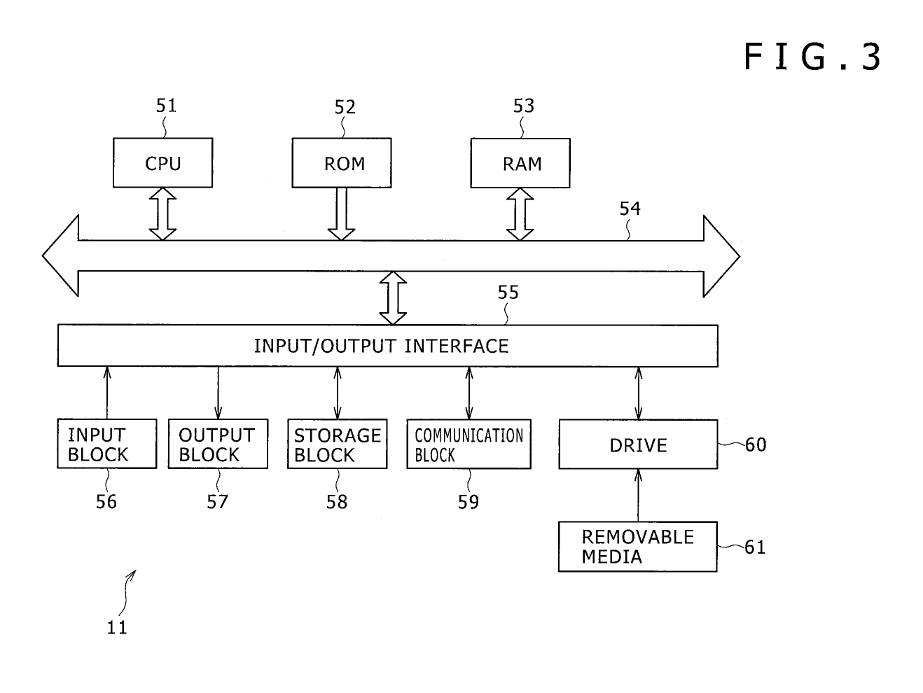

FIG. 3 is a block diagram showing a typical hardware structure of the server 11.

The server 11 includes a CPU (central processing unit) 51, a ROM (read only memory) 52, a RAM (random access memory) 53, a bus 54, an input/output interface 55, an input block 56, an output block 57, a storage block 58, a communication block 59, and a drive 60.

The CPU 51 performs various processes in accordance with the programs recorded in the ROM 52. Alternatively, the CPU 51 carries out diverse processes in accordance with the programs loaded from the storage block 58 into the RAM 53. The RAM 53 may also store data and other resources needed by the CPU 51 in performing the various processes as appropriate.

The CPU 51, ROM 52, and RAM 53 are interconnected with one another via the bus 54. The bus 54 is further connected with the input/output interface 55. The input/output interface 55 is connected with the input block 56, output block 57, storage block 58, and communication block 59.

The input block 56 is generally composed of a keyboard, a mouse, and a microphone. The output block 57 is typically made of a display unit and speakers and outputs various images.

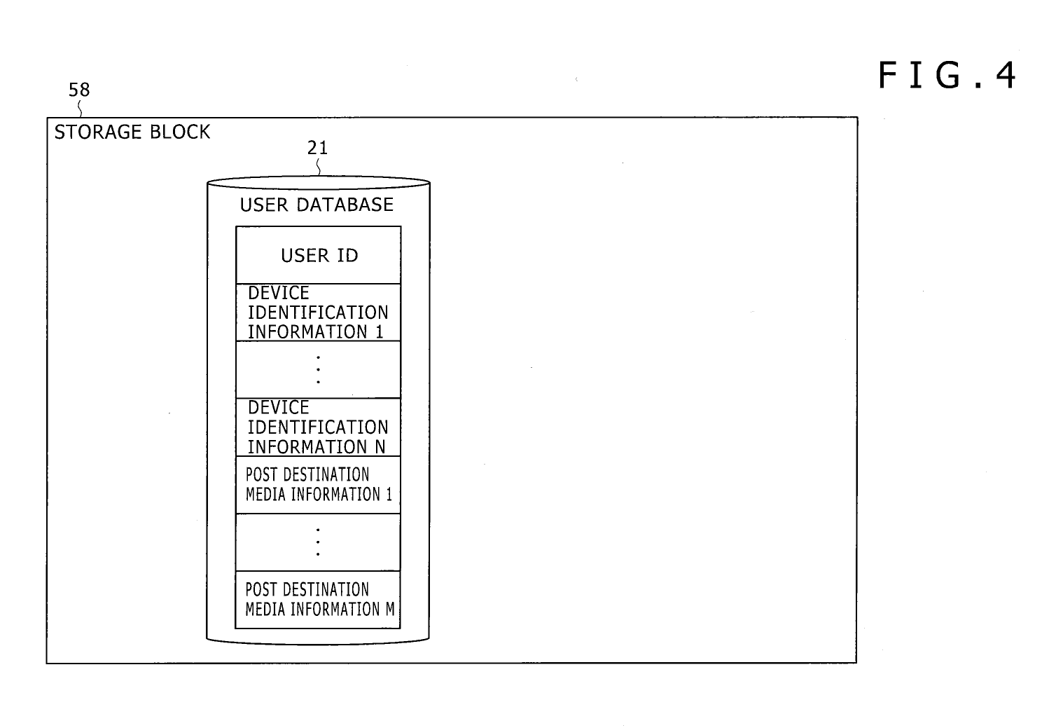

The storage block 58 is formed by a hard disk or a nonvolatile memory, for example, and stores diverse information as well as the user database 21. The user database 21 will be discussed later in detail by reference to FIG. 4.

The communication block 59 controls communications with the user terminal 31, media management server 32, and a sponsor terminal 33 via the network 34 including the Internet.

The input/output interface 55 is also connected with the drive 60 as needed. Removable media 61 such as a magnetic disk, an optical disk, a magneto-optical disk, or a semiconductor memory may be loaded into the drive 60 as appropriate. Computer programs read by the drive 60 from the loaded medium are installed into the storage block 58 as needed.

### [Details of the Database]

FIG. 4 is a schematic view showing a detailed structure of the user database 21 stored in the storage block 58.

The user database 21 stores user IDs, N pieces of device identification information 1 through N (N is an integer of at least 1), and M pieces of post destination media information 1 through M (M is an integer of at least 1).

The user ID is the information that identifies the user. The N pieces of device identification information 1 through N can individually identify the user terminals 1 through N to be used by the users identified by the user IDs. The M pieces of post destination media information 1 through M denote the post destination media 1 through M respectively.

The user IDs are associated with the device identification information 1 through N. Each of the N pieces of device identification information 1 through N is associated with one of the M pieces of post destination media information 1 through M as designated by the user.

### [Typical Hardware Structure of the User Terminal]

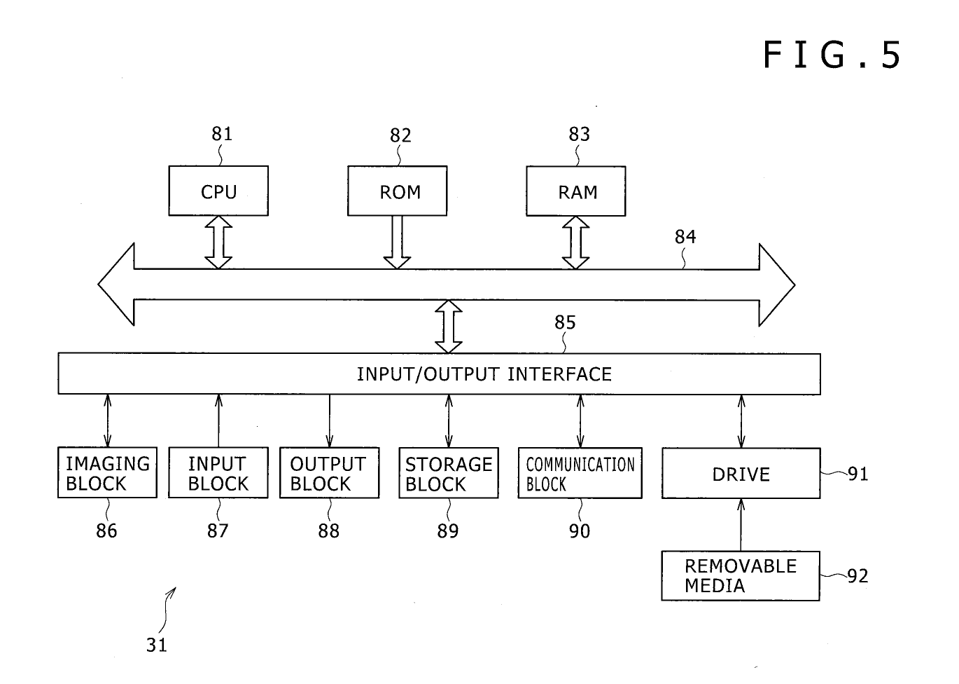

FIG. 5 is a block diagram showing a typical hardware structure of the user terminal 31.

The user terminal 31 includes a CPU 81, a ROM 82, a RAM 83, a bus 84, an input/output interface 85, an imaging block 86, an input block 87, an output block 88, a storage block 89, a communication block 90, a drive 91, and removable media 92.

The user terminal 31 basically has the same functionality and structure as the server 11 in FIG. 3. The components already discussed above in connection with the server 11 will not be explained further.

The imaging block 86 takes images of an object and outputs image data. The imaging block 86 has an image pickup device such as a CCD (charge coupled device) or a CMOS (complementary metal oxide semiconductor) with which to image the object and outputs the data of the imaged object.

The foregoing paragraphs have explained the hardware structures of the server 11 and user terminal 31. What follows is an explanation of the functional structures of the server 11 and user terminal 31.

### [Typical Functional Structure of the Server]

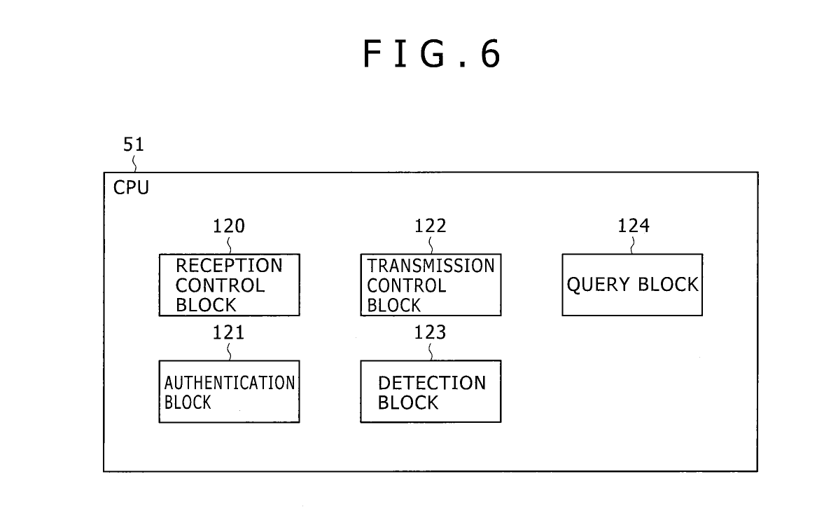

FIG. 6 is a block diagram showing a typical functional structure of the CPU 51 of the server 11 indicated in FIG. 3.

The CPU 51 includes a reception control block 120, an authentication block 121, a transmission control block 122, a detection block 123, and a query block 124.

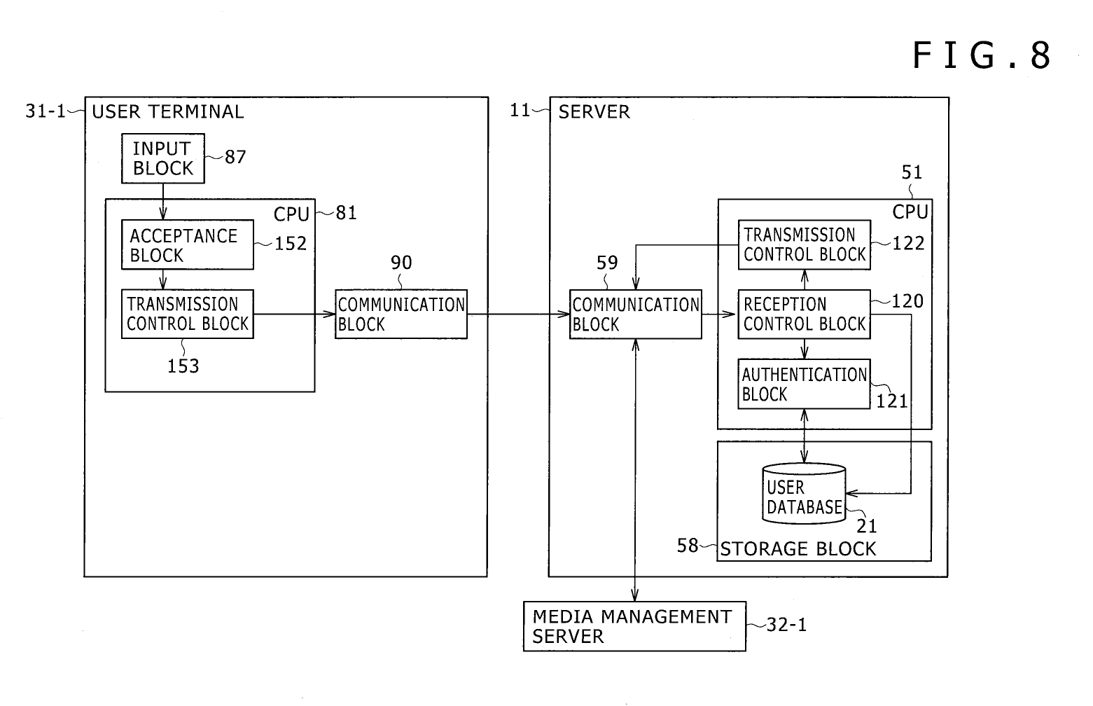

The functions of the components ranging from the reception control block 120 to the query block 124 will be discussed later in detail by reference to FIGS. 8 through 11.

### [Typical Functional Structure of the User Terminal]

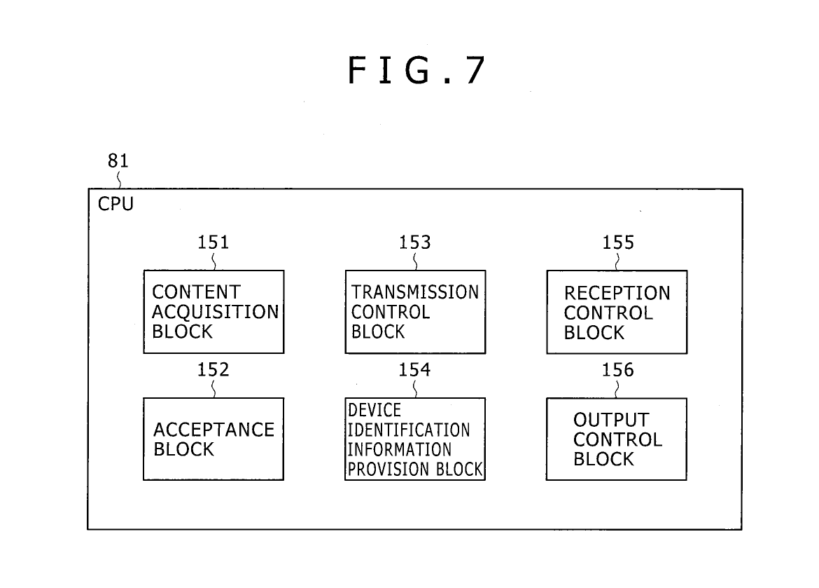

FIG. 7 is a block diagram showing a typical functional structure of the CPU 81 of the user terminal 31 indicated in FIG. 5.

The CPU 81 includes a content acquisition block 151, an acceptance block 152, a transmission control block 153, a device identification information provision block 154, a reception control block 155, and an output control block 156.

The functions of the components ranging from the content acquisition block 151 to the output control block 156 will be discussed later in detail by reference to FIGS. 8 through 11.

### [User-Operated Device Registration Process]

Explained below is a user-operated device registration process made up of a series of processes performed by the information processing system 1 upon registration of the user terminal to be used by the user. It is assumed here that the user terminal 31-1 is registered as the user terminal to be used by the user.

[Typical Functional Structures of the Server and User Terminal upon Execution of the User-Operated Device Registration Process]

FIG. 8 is a function block diagram showing those of the functions of the CPU 51 in the server 11 in FIG. 3 and of the functions of the CPU 81 in the user terminal 31 in FIG. 5 that may be used to implement the user-operated device registration process.

When the user-operated device registration process is to be carried out on the user terminal 31-1, the CPU 81 causes the acceptance block 152 and transmission control block 153 to function, as shown in FIG. 8.

Upon execution of the user-operated device registration process on the server 11, the CPU 51 causes the reception control block 120, authentication block 121, and transmission control block 122 to function, as shown in FIG. 8.

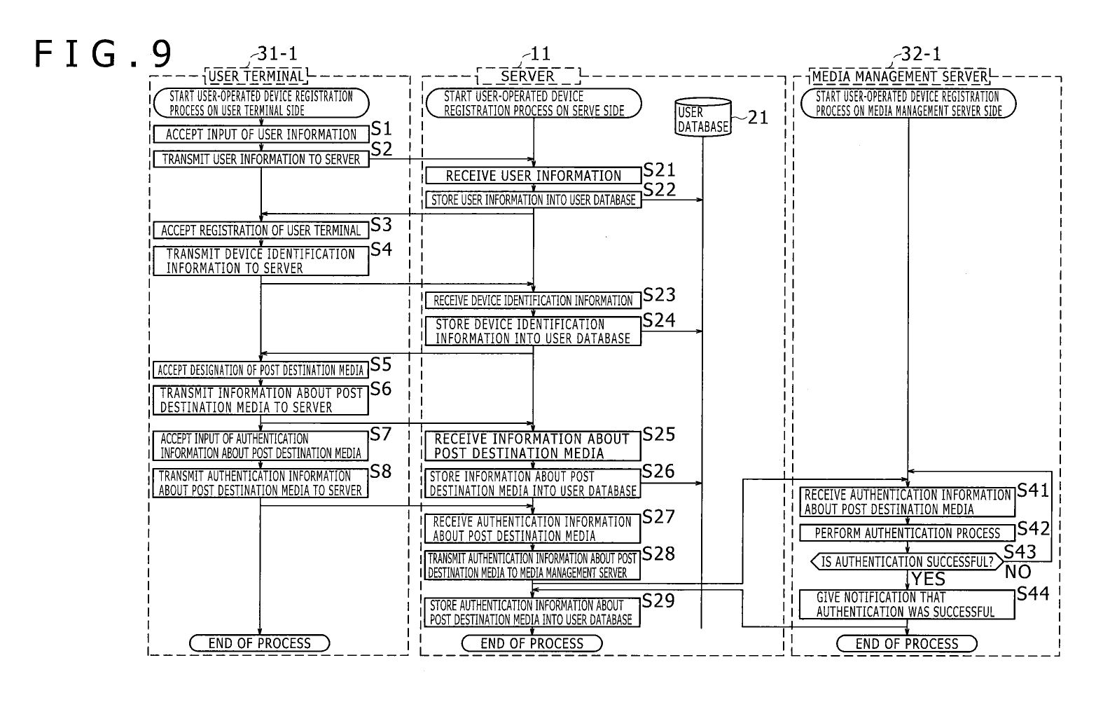

The flow of the user-operated device registration process is explained below in reference to FIG. 9. Throughout the explanation, details of each of the function blocks shown in FIG. 8 will also be discussed.

### [Flow of the User-Operated Device Registration Process]

FIG. 9 is a flowchart explaining the flow of the user-operated device registration process. The flowchart of FIG. 9 is made up of three flowcharts: the left-hand flowchart explaining the flow of the user-operated device registration process on the side of the user terminal 31-1; the middle flowchart explaining the flow of the user-operated device registration process on the side of the server 11, and the right-hand flowchart explaining the flow of the user-operated device registration process on the side of the media management server 32-1 managing the post destination media associated with the user terminal 31-1. The horizontal arrows connecting the three flowcharts in FIG. 9 indicate the flow of information.

In step S1, the acceptance block 152 of the user terminal 31-1 accepts the user information input by the user operating the input block 87. The user information is information for logging into the information processing system 1, including a user ID and a password in particular.

In step S2, the transmission control block 153 transmits the user information to the server 11. Exchanges of information with the server 11 are conducted by the transmission control block 153 or reception control block 155 controlling the communication block 90.

In step S21, the reception control block 120 of the server 11 receives the user information transmitted from the user terminal 31-1. Exchanges of information with the user terminal 31-1 are performed by the reception control block 120 or transmission control block 122 controlling the communication block 59.

In step S22, the authentication block 121 registers the user by storing the received user information into the user database 21.

The preceding step completes the process performed on the server 11 to let the user terminal 31-1 log in. The server 11 notifies the user terminal 31-1 that the login process is completed.

In step S3, the acceptance block 152 of the user terminal 31-1 accepts the registration of the user terminal 31-1 input by the user operating the input block 87.

In step S4, the transmission control block 153 transmits to the server 11 the device identification information about the user terminal 31-1 of which the registration has been accepted.

In step S23, the reception control block 120 of the server 11 receives the device identification information transmitted from the user terminal 31-1.

In step S24, the reception control block 120 stores into the user database 21 the device identification information in association with the user information stored in step S22.

In step S5, the acceptance block 152 of the user terminal 31-1 accepts the designation of the post destination media input by the user operating the input block 87.

In step S6, the transmission control block 153 transmits to the server 11 the information about the post destination media of which the designation has been accepted by the acceptance block 152.

In step S25, the reception control block 120 of the server 11 receives the information about the post destination media transmitted from the user terminal 31-1.

In step S26, the reception control block 120 stores into the user database 21 the information about the post destination media in association with the device identification information stored in step S24.

In step S7, the acceptance block 152 of the user terminal 31-1 accepts the authentication information about the post destination media input by the user operating the input block 87.

In step S8, the transmission control block 153 transmits the authentication information about the post destination media to the server 11.

The preceding step completes the user-operated device registration process on the side of the user terminal 31-1.

In step S27, the reception control block 120 of the server 11 receives the authentication information about the post destination media transmitted from the user terminal 31-1.

In step S28, the transmission control block 122 transmits the authentication information about the post destination media to the media management server 32-1.

In step S41, the media management server 32-1 receives the authentication information about the post destination media transmitted from the server 11.

In step S42, the media management server 32-1 performs an authentication process based on the authentication information.

In step S43, the media management server 32-1 determines whether the authentication is successfully completed.

If it is determined in step S43 that the authentication has failed, process is returned to step S41 and the subsequent steps are repeated. That is, a looping process made of steps S41 through S43 is repeated until the authentication is successfully completed. If the authentication remains unsuccessful, the media management server 32-1 notifies the server 11 of the unsuccessful authentication. In turn, the server 11 notifies the user terminal 31-1 that the authentication has failed. Given the notification from the server 11, the user terminal 31-1 returns to step S7. That is, until the authentication is successfully completed, steps S7 and S8 are repeated on the user terminal 31-1 and steps S27 and S28 are repeated on the server 11.

On the other hand, if it is determined in step S43 that the authentication is successfully completed, control is passed to step S44. For example, the authentication is determined to be successful if the authentication information such as the password transmitted from the server 11 coincides with the authentication information registered in the media management server 32-1 in advance.

In step S44, the media management server 32-1 transmits to the server 11 the notification that the authentication is successfully completed.

The preceding step completes the user-operated device registration process on the side of the media management server 32-1.

On the side of the server 11, the reception control block 120 receives the notification transmitted from the media management server 32-1. At this point, process proceeds to step S29.

In step S29, the reception control block 120 of the server 11 stores into the user database 21 the authentication information about the post destination media in association with the user information stored in step S22.

The preceding step completes the user-operated device registration process on the side of the server 11.

In the user-operated device registration process, as explained above, the device identification information about each user terminal is registered in the server 11 beforehand in association with the post destination media to be used by the user terminal in question.

### [Content Posting Process]

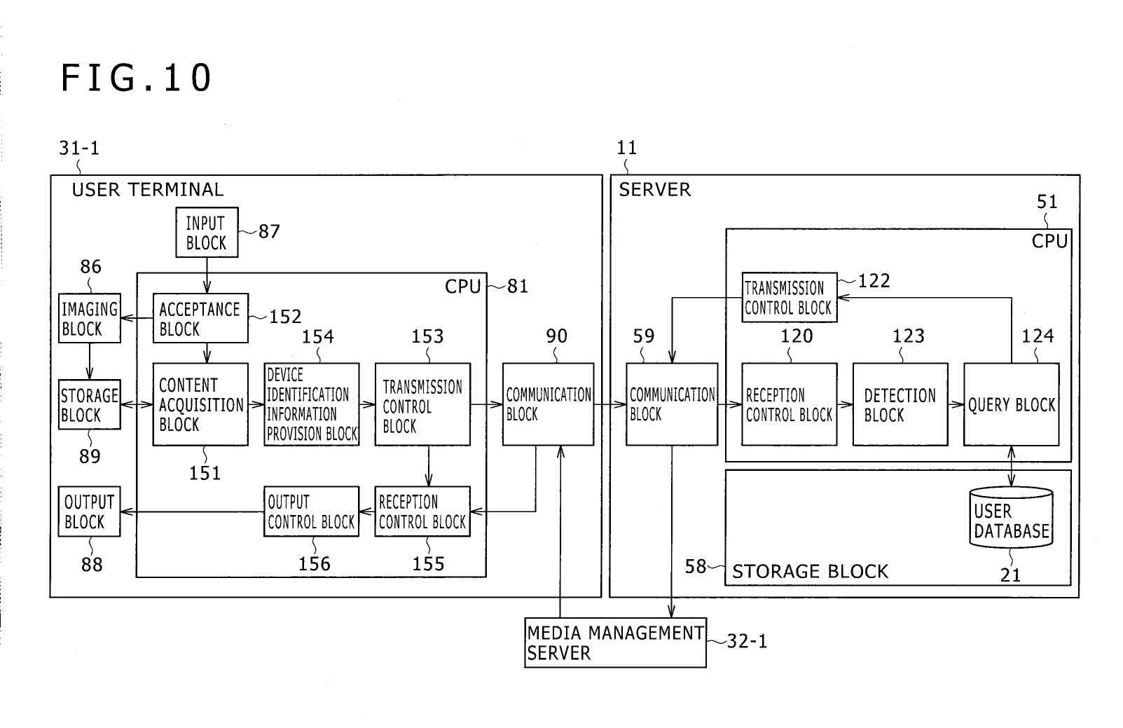

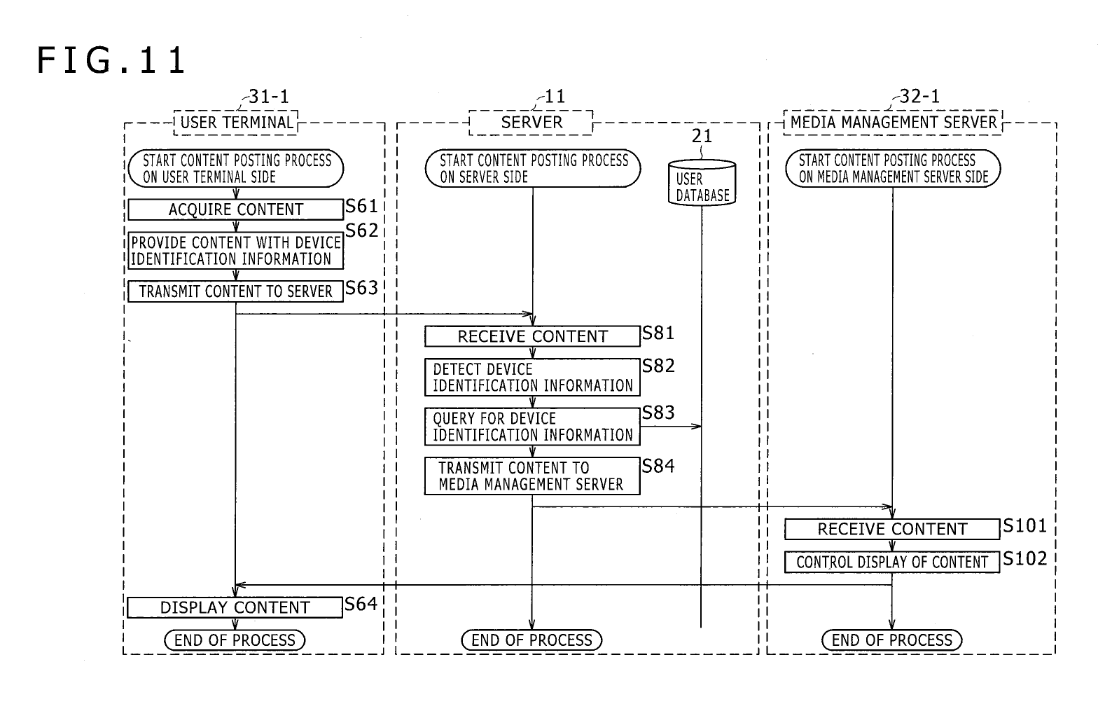

Explained below in reference to FIGS. 10 and 11 is a content posting process made up of a series of processes in which the information processing system 1 displays the content generated by the user and posted to the post destination media. It is assumed here that the user terminal 31-1 is used to post the content.

[Typical Functional Structures of the Server and User Terminal upon Execution of the Content Posting Process]

FIG. 10 is a function block diagram showing those of the functions of the CPU 51 in the server 11 in FIG. 3 and of the functions of the CPU 81 in the user terminal 31 in FIG. 5 that may be used to implement the content posting process.

Where the content posting process is to be carried out on the user terminal 31-1, the CPU 81 causes the content acquisition block 151, acceptance block 152, transmission control block 153, device identification information provision block 154, reception control block 155, and output control block 156 to function, as shown in FIG. 10.

Upon execution of the content posting process on the server 11, the CPU 51 causes the reception control block 120, transmission control block 122, detection block 123, and query block 124 to function, as shown in FIG. 10.

The flow of the content posting process is explained below in reference to FIG. 11. Throughout the explanation, details of each of the function blocks shown in FIG. 10 will also be discussed.

### [Flow of the Content Posting Process]

FIG. 11 is a flowchart explaining the flow of the content posting process. The flowchart of FIG. 11 is made up of three flowcharts: the left-hand flowchart explaining the flow of the content posting process on the side of the user terminal 31-1; the middle flowchart explaining the flow of the content posting process on the side of the server 11, and the right-hand flowchart explaining the flow of the content posting process on the side of the media management server 32-1. The horizontal arrows connecting the three flowcharts in FIG. 11 indicate the flow of information.

In step S61, the content acquisition block 151 of the user terminal 31-1 acquires content from the storage block 89 based on a content acquisition instruction accepted by the acceptance block 152. The content stored in the storage block 89 is the UGC generated by the user. For example, the storage block 89 stores the content made up of the images of objects taken by the imaging block 86 by the user operating the input block 87.

In step S62, the device identification information provision block 154 provides device identification information to the content acquired by the content acquisition block 151.

In step S63, the transmission control block 153 transmits to the server 11 the content provided with the device identification information by the device identification information provision block 154.

In step S81, the reception control block 120 of the server 11 receives the content transmitted from the user terminal 31-1.

In step S82, the detection block 123 detects the device identification information from the received content.

In step S83, the query block 124 queries whether the detected device identification information is registered in the user database 21. Since the device identification information about the user terminal 31-1 has already been registered, the query block 124 acquires the information about the post destination media associated with the registered device identification information.

In step S84, based on the acquired information about the post destination media, the transmission control block 122 transmits the content to the media management server 32-1 that manages the post destination media.

The preceding step completes the content posting process on the side of the server 11.

In step S101, the media management server 32-1 receives the content transmitted from the server 11.

In step S102, the media management server 32-1 controls content display on the user terminal 31-1 by transmitting diverse data and control information to the user terminal 31-1.

The preceding step completes the content posting process on the side of the media management server 32-1.

On the side of the user terminal 31-1, the reception control block 155 receives the diverse data and control information transmitted from the media management server 32-1. At this point, process proceeds to step S64.

In step S64, the output control block 156 causes the output block 88 to display the content based on the diverse data and control information from the media management server 32-1.

The preceding step completes the content posting process on the side of the user terminal 31-1.

In the information processing system 1 of the disclosed technology, as explained above, the device identification information about each user terminal is registered in the server 11 beforehand in association with the post destination media to be used by the user terminal. When a given user terminal generates content, the generated content is provided with the device identification information about that user terminal before being transmitted to the server 11. Based on the device identification information, the server 11 can identify the post destination media associated with the user terminal in question and transfer the content to the identified post destination media.

In this manner, the user can not only make selective use of different services on each of a plurality of user terminals but also dispense with selection operations on a given terminal upon selectively using the service assigned to that terminal.

### [Application Examples of the Information Processing System 1]

The information processing system 1 can be applied to the service in which user-generated UGC is given a link to an advertisement site so that the linked UGC works as affiliate media constituting advertising media. The information processing system applied to that service is called the information processing system 100 hereunder.

### [Typical Configuration of the Information Processing System 100]

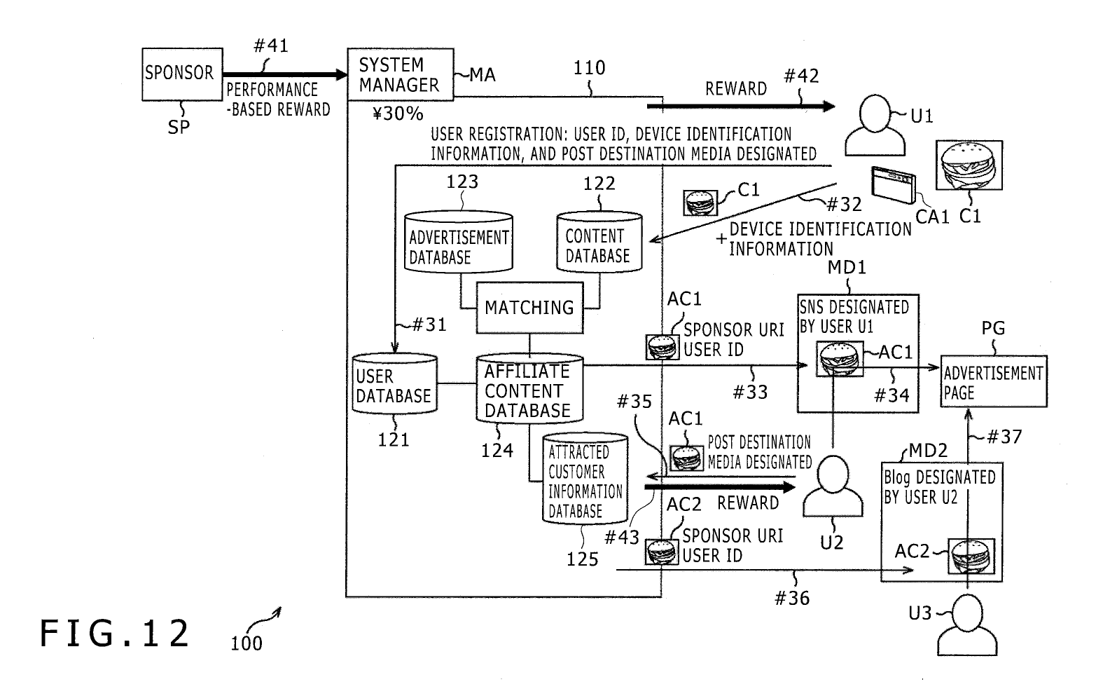

FIG. 12 shows a typical configuration of a model implemented by the information processing system 100.

In the model shown in FIG. 12, the details of the UGC are first analyzed and a link is attached to the advertising site of the company (i.e., sponsor) associated with the analyzed details. Then the UGC linked to the advertising site is uploaded onto the network for viewing by other users. The other users may proceed to take certain actions as viewing the advertising site via the link attached to the UGC in order to register as members at the advertising site or purchase products from that site. When the advertising site is viewed in this manner, the users are each paid a reward. That is, the UGC works as affiliate media constituting advertisement media.

The participants in the above-described model of this technology are made up of at least one sponsor (one sponsor SP in the example of FIG. 12), at least one system manager (one system manager MA in the example of FIG. 12), and at least one user (three users U1 through U3 in the example of FIG. 12). In the ensuing description, the users U1 through U3 will be generically referred to as the user U if there is no need to distinguish the individual users from one another.

The sponsor SP manages its advertisement page PG using a sponsor terminal. The sponsor SP commissions the system manager MA to set up links of the advertisement page PG with diverse UGCs.

Given the commission from the sponsor SP, the system manager MA uses a sever 110 to link the advertisement page PG with, say, the UGC generated by the user U1, i.e., to perform the task of associating the UGC with the advertisement page PG. Also using the server 110, the system manager MA causes the UGC associated with the advertisement page PG to be reproduced by the post destination media registered beforehand in association with the user terminal that has generated the UGC in question.

The server 110 managed by the system manager MA includes a user database 121, a content database 122, an advertisement database 123, an affiliate content database 124, and an attracted customer information database 125.

The user database 121 stores the information about a plurality of users U having made user registration through the server 110. In the example of FIG. 12, the user U1 has already made the user registration as indicated by arrow #31. The user database 121 stores the user information about the user U1. Also, the user database 121 stores the device identification information about each of user terminals CA1 through CAN registered by the user U1 as well as the information about the post destination media designated by the user U1 with regard to each of the user terminals CA1 through CAN.

The content database 122 stores the UGCs from a plurality of users U. In the example of FIG. 12, the device identification information about the user terminal CA1 is attached to content C1 of a hamburger image taken by the user U1 using the user terminal CA1. The user U1 transmits the content C1 provided with the device identification information to the server 110 as indicated by arrow #32. Upon receipt of the content C1, the server 110 stores it into the content database 122.

The advertisement database 123 stores the information about the sponsor SP. In the example of FIG. 12, the advertisement database 123 stores the advertisement ID of the advertisement page PG, the URI (Uniform Resource Identifier) of the advertisement page PG, the ID of the sponsor SP, and keywords associated with the advertisement page PG.

When the content C1 is stored into the content database 122, the server 110 analyzes the details of the content C1 and extracts a keyword from the content C1 based on the result of the analysis.

It should be noted here that the content C1 is multimedia content composed of video and/or audio data without a text serving as a keyword. Thus the server 110 analyzes the details of the content C1 to acquire, for example, a character string recognized as part of the image of the content C1, a background recognized in the image, position information about the image, and/or the sound as part of the content C1.

Using appropriate techniques, the server 110 identifies a text associated with the analyzed details of the content C1 and extracts the text as the keyword of the content C1.

The server 110 proceeds to match the extracted keyword against the keywords stored in the advertisement database 123 in association with the advertisement page PG.

If the extracted keyword matches any of the keywords associated with the advertisement page PG, the server 110 associates the content. C1 with the URI of the advertisement page PG. The content AC1 associated in this manner with the URI of the advertisement page PG (i.e., linked to the page GP) functions as affiliate media as discussed above. This content will thus be referred to as affiliate content AC1 hereunder. In other words, the server 110 generates the affiliate content AC1 by associating the URI of the advertisement page PG with the content C1.

Furthermore, the server 110 reads the user ID of the user U1 from the server database 121 and attaches the retrieved user ID to the affiliate content AC1.

From the affiliate content AC1 provided with the user ID, the server 110 detects device identification information. The server 110 queries whether the detected device identification information is registered in the user database 121 so as to acquire the information about the post destination media associated with the device identification information in question. Based on the acquired information about the post destination media, the server 110 transmits the affiliate content AC1 to the media management server that manages the post destination media associated with the device identification information.

In the case of FIG. 12, post destination media MD1 working as an SNS is designated by the user U1 beforehand with regard to the user terminal CA1. For this reason, the affiliate content AC1 is transmitted to the media management server managing the post destination media MD1 as indicated by arrow #33. This allows the affiliate content AC1 to be shared with other users such as the user U2 on the post destination media MD1. That is, the user U2 can view the affiliate content AC1 displayed on his or her user terminal.

Suppose that while viewing the affiliate content AC1 on the post destination media MD1 using his or her user terminal, the user U2 performs an operation (e.g., a click) to select the affiliate content AC1. In this case, as indicated by arrow #34, a redirect is made to the advertisement page PG found at the URI associated with the affiliate content AC1 so that the advertisement page PG is displayed on a display unit of the user terminal of the user U2. This means that the user U2 is attracted to the advertisement page PG of the sponsor SP. At this point, the server 110 stores into the attracted customer information database 125 the number of times the affiliate content AC1 has attracted other users U to the advertisement page PG.

What follows is a detailed explanation of the reuse of the affiliate content AC1 by the user U2. It is assumed that not only the user U1 but also the user U2 has made the user registration and that the user database 121 stores, among others, the user ID of the user U2 and the information about the post destination media designated by the user U2 as indicated by arrow #35.

While viewing the affiliate content AC1 via the post destination media MD1 using his or her user terminal, the user U2 performs a predetermined operation to transmit request to reuse the affiliate content AC1 to the server 110. In turn, the server 110 makes a copy of the affiliate content AC1 to generate affiliate content AC2. Furthermore, the server 110 reads the user ID of the user U2 from the user database 121 and attaches the retrieved user ID to the affiliate content AC2. The server 110 transmits the affiliate content AC2 provided with the user ID to the media management server that manages the post destination media designated by the user U2.

In the case of FIG. 12, the user U2 has designated in advance post destination media MD2 serving as a blog. Thus the affiliate content AC2 is transmitted to the media management server managing the post destination media MD2 as indicated by arrow #36. This allows the affiliate content AC2 to be shared with still other users U such as the user U3 on the post destination media MD2. That is, the user U3 can view the affiliate content AC2 displayed on his or her user terminal.

Suppose that while viewing the affiliate content AC2 on the post destination media MD2 using his or her user terminal, the user U3 performs an operation (e.g., a click) to select the affiliate content AC2. In this case, as indicated by arrow #37, a redirect is made to the advertisement page PG found at the URI associated with the affiliate content AC2 so that the advertisement page PG is displayed on a display unit of the user terminal of the user U3. This means that the user U3 is attracted to the advertisement page PG of the sponsor SP. At this point, the server 110 stores into the attracted customer information database 125 the number of times the affiliate content AC2 has attracted other users U to the advertisement page PG.

Likewise, the user U3 can reuse the affiliate content AC2, and many other users Uk (k is an integer of at least 2), not shown in FIG. 12, can reuse affiliate content ACk. That is, the content C1 associated with the URI of the advertisement page PG gives birth to a growing number (=N which is an integer of at least 1) of copies of the original (i.e., affiliate contents AC1 through ACN), the copies spreading to various post destination media (including the post destination media MD1 and MD2 in FIG. 12) on the network. Throughout the spread, the copies of the original content are viewed by numerous users U. This can boost the prospect of a large number of potential customers getting attracted to the advertisement page PG.

At this point, the system manager MA and the users U1 through U3 are each paid a reward as a performance-based pay from the sponsor SP as indicated by arrows #41 through #43. Specifically, the system manager MA is paid a reward for a predetermined contribution to the process of attracting customers.

In principle, the user U1 who generated the content C1 may be paid a reward in proportion to the number of times the advertisement page PG has been viewed by the other users U via the affiliate content AC1 generated from the original content C1.

Also, the users U2 and U3 may be each paid a reward in proportion to the number of times the advertisement page PG has been viewed by the other users U via, the affiliate content AC2 copied from the affiliate content AC1.

As explained above, the user U1 operating the user terminal CA1 can share the content C1 with other users such as the users U2 and U3 in diverse fashion.

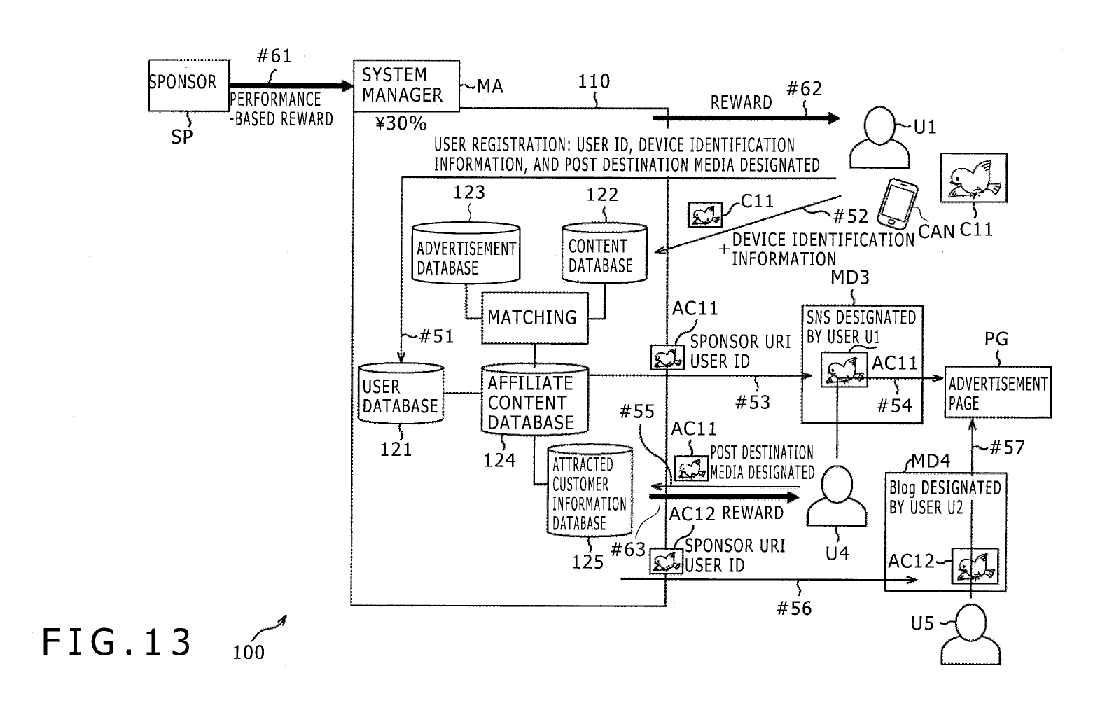

In like manner, as will be explained below in reference to FIG. 13, the user U1 operating the user terminal CAN may share content C11 different from the content C1 in diverse fashion with other users excluding the users U2 and U3.

### [Another Typical Configuration of the Information Processing System 100]

FIG. 13 shows another typical configuration of the same model as that in FIG. 12. What makes the configuration of FIG. 13 different from that of FIG. 12 is that the user terminal CAN is used in place of the user terminal CA1 shown in FIG. 12.

In the example of FIG. 13, the user U1 takes an image of a bird using the user terminal CAN. The user terminal CAN then attaches the device identification information about the user terminal CAN to content C11 made up of the image of the bird thus acquired. The user U1 transmits the content C11 provided with the device identification information to the server 110 as indicated by arrow #52. Upon receipt of the content C11, the server 110 stores it into the content database 122.

When the content C11 is stored into the content database 122, the server 110 analyses the details of the content C11 and extracts a keyword from the content C11 based on the result of the analysis. The server 110 then matches the extracted keyword against the keywords stored in the advertisement database 123 in association with the advertisement page PG.

If the extracted keyword matches any of the keywords associated with the advertisement page PG, the server 110 associates the content C11 with the URI of the advertisement page PG so as to generate affiliate content AC11. The server 110 reads the user ID of the user U1 from the user database 121 and attaches the retrieved user ID to the affiliate content AC11.

In the case of FIG. 13, post destination media MD3 working as an SNS is designated by the user U1 beforehand with regard to the user terminal CAN. For this reason, the affiliate content AC11 is transmitted to the media management server managing the post destination media MD3 as indicated by arrow #53. This allows the affiliate content AC11 to be shared with other users such as a user U4 on the post destination media MD3. That is, the user U4 can view the affiliate content AC11 displayed on his or her user terminal.

Comparing FIG. 13 with FIG. 12 reveals that in the case of FIG. 12, the content C1 generated by the user terminal CA1 becomes the affiliate content AC1 to be shared with the user U2 on the post destination media MD1. In the case of FIG. 13, on the other hand, the content C11 generated by the user terminal CAN becomes the affiliate content AC11 to be shared with the user U4 different from the user in FIG. 12 on the post destination media MD3 different from the media in FIG. 12. In this manner, by selectively using different user terminals, the user can change as desired the other users who will share the affiliate content and the post destination media to which to post the content.

In the case of FIG. 13, as indicated by arrows #55 and #56, the flow in which affiliate content AC12 comes to be shared with another user U5 on post destination media MD4 through the reuse by the user U4 will not be discussed hereunder. That is because the flow is basically the same as the corresponding flow in the case of FIG. 12 where, as indicated by arrows #35 and #36, the affiliate content AC2 comes to be shared with another user U3 on the post destination media MD2 through the reuse by the user U2. Likewise, the manner in which rewards are paid as indicated by arrows #61 through #63 in FIG. 13 is basically the same as the manner of reward payment in FIG. 12 as indicated by arrows #41 through #43 and thus will not be discussed further.

As explained above in reference to FIGS. 12 and 13, the primary user can not only make selective use of different services on each of a plurality of user terminals but also dispense with selection operations on a given terminal upon selectively using the service assigned to that terminal. The primary user can also associate the UGC such as multimedia content with the URI of the advertisement page PG. Furthermore, the users U who diversely share the UGC will also be paid a reward each from the sponsor SP.

### [Application of the Present Technology to Programs]

The series of processes described above may be executed either by hardware or by software. Where the processes are to be carried out by software, the programs constituting the software are installed into a suitable computer for execution. Such computers may include those with the software incorporated in their dedicated hardware beforehand, and those such as general-purpose personal computers or the like capable of executing diverse functions based on various programs installed therein.

For example, the above-mentioned series of processes may be carried out by the CPU 51 of the server 11 in FIG. 3 or by the CPU 81 of the user terminal 31 in FIG. 5 (both typical computers) loading relevant programs from the storage block 58 in FIG. 3 or from the storage block 89 in FIG. 5 into the RAM 53 in FIG. 3 or into the RAM 83 in FIG. 5 via the input/output interface 55 in FIG. 3 or via the input/output interface 85 in FIG. 5 through the bus 54 in FIG. 3 or through the bus 84 in FIG. 5, and executing the loaded programs.

The programs to be executed by the computer may be offered recorded on the removable media 61 in FIG. 3 or on the removable media 92 in FIG. 5 constituting package media or the like. The programs may also be offered by way of wired or wireless transmission media such as local area networks, the Internet, or digital satellite broadcasts.

When a suitable piece of the removable media 61 in FIG. 3 or of the removable media 92 in FIG. 5 carrying the relevant programs is attached to the drive 60 in FIG. 3 or to the drive 91 in FIG. 5, the programs may be installed from the attached medium into the storage device 58 in FIG. 3 or into the storage device 89 in FIG. 5 through the input/output interface 55 in FIG. 3 or through the input/output interface 85 in FIG. 5. Alternatively, the programs may be received by the communication block 59 in FIG. 3 or by the communication block 90 in FIG. 5 through wired or wireless transmission media before getting installed into the storage block 58 in FIG. 3 or into the storage block 89 in FIG. 5. As another alternative, the programs may be preinstalled in the ROM 52 in FIG. 3, in the ROM 82 in FIG. 5, in the storage block 58 in FIG. 3, or in the storage block 89 in FIG. 5.

Also, the programs to be executed by the computer may be processed in the depicted sequence of this specification (i.e., on a time series basis), in parallel, or in otherwise appropriately timed fashion such as when they are invoked as needed.

While a preferred embodiment of the present disclosure has been described above, such description is for illustrative purpose only, and it is to be understood that changes and variations may be made without departing from the spirit or scope of the following claims.

For example, the disclosed technology may be implemented as a cloud computing setup in which a single function is processed cooperatively by a plurality of networked apparatuses operating on a sharing basis.

Also, each of the steps discussed above in reference to the attached flowcharts may be carried out either by a single apparatus or by a plurality of apparatuses operating on a sharing basis.

Furthermore, if any one step includes a plurality of processes, these processes may be carried out either by a single apparatus or by a plurality of apparatuses operating on a sharing basis.

The disclosed technology may also be configured as follows:

(1) An information processing apparatus including:

a storage block configured to store identification information about a device in association with information about a post destination; and

a transmission control block configured to transmit content which has been sent from the device and which is provided with the identification information to the post destination associated with the identification information.

(2) The information processing apparatus as described in paragraph (1) above, wherein

the storage block stores the identification information transmitted from either the device or another device used by a user in association with the information about the post destination.

(3) The information processing apparatus as described in paragraph (1) or (2) above, further including:

a detection block configured to detect the identification information from the content; and

a query block configured to query whether the identification information detected by the detection block is stored in the storage block so as to acquire from the storage block the information about the post destination associated with the identification information;

wherein the transmission control block transmits the content to the post destination based on the information about the post destination acquired by the query block.

(4) The information processing apparatus as described in paragraph (1) or (3) above, wherein

the identification information is the serial number of the device.

(5) The information processing apparatus as described in any of paragraphs (1) through (4) above, wherein

the transmission control block transmits authentication information about the post destination sent from the device to the post destination, and

the storage block stores the authentication information if the post destination is successfully authenticated.

(6) An information processing apparatus including:

a transmission control block configured to transmit identification information about the information processing apparatus and information about a post destination to which content is to be transmitted;

an acquisition block configured to acquire the content; and

an identification information provision block configured to provide the content acquired by the acquisition block with the identification information;

wherein the transmission control block transmits the content provided with the identification information by the identification information provision block to a server in which the information processing apparatus is registered.

(7) An information processing system including:

a user terminal; and

a server;

the user terminal having
a transmission control block configured to transmit identification information about the user terminal and information about a post destination to which content is to be transmitted;
an acquisition block configured to acquire the content, and
an identification information provision block configured to provide the content acquired by the acquisition block with the identification information;
the transmission control block transmitting the content provided with the identification information by the identification information provision block to a server in which the user terminal is registered, and

the server having
a storage block configured to store the identification information in association with the information about the post destination, and
a transmission control block configured to transmit the content which has been sent from the user terminal and which is provided with the identification information to the post destination associated with the identification information.

The technology of the present disclosure may be applied extensively to information processing apparatuses each offering a plurality of services, among others.

The present disclosure contains subject matter related to that disclosed in Japanese Priority Patent Application JP 2012-063077 filed in the Japan Patent Office on Mar. 21, 2012, the entire content of which is hereby incorporated by reference.

What is claimed is:

1. An information processing apparatus comprising:
a storage block configured to store identification information about a device in association with information about a post destination; and
a transmission control block configured to transmit content which has been sent from said device and which is provided with said identification information to said post destination associated with said identification information.

2. The information processing apparatus according to claim 1, wherein
said storage block stores said identification information transmitted from either said device or another device used by a user in association with the information about said post destination.

3. The information processing apparatus according to claim 2, further comprising:
a detection block configured to detect said identification information from said content; and
a query block configured to query whether said identification information detected by said detection block is stored in said storage block so as to acquire from said storage block the information about said post destination associated with said identification information;
wherein said transmission control block transmits said content to said post destination based on the information about said post destination acquired by said query block.

4. The information processing apparatus according to claim 3, wherein
said transmission control block transmits authentication information about said post destination sent from said device to said post destination, and
said storage block stores said authentication information if said post destination is successfully authenticated.

5. The information processing apparatus according to claim 1, wherein
said identification information is the serial number of said device.

6. An information processing method comprising:
storing identification information about a device in association with information about a post destination; and
transmitting content which has been sent from said device and which is provided with said identification information to said post destination associated with said identification information.

7. A program for causing a computer to function as an apparatus comprising:
a storage block configured to store identification information about a device in association with information about a post destination; and
a transmission control block configured to transmit content which has been sent from said device and which is provided with said identification information to said post destination associated with said identification information.

8. An information processing apparatus comprising:
a transmission control block configured to transmit identification information about said information processing apparatus and information about a post destination to which content is to be transmitted;
an acquisition block configured to acquire the content; and
an identification information provision block configured to provide said content acquired by said acquisition block with said identification information;
wherein said transmission control block transmits said content provided with said identification information by said identification information provision block to a server in which said information processing apparatus is registered.

9. An information processing method comprising:
transmitting identification information about an apparatus and information about a post destination to which content is to be transmitted;
acquiring the content; and
providing the acquired content with said identification information;
wherein said content provided with said identification information is transmitted to a server in which said apparatus is registered.

10. A program for causing a computer to function as an apparatus comprising:
a transmission control block configured to transmit identification information about said apparatus and information about a post destination to which content is to be transmitted;
an acquisition block configured to acquire the content; and
an identification information provision block configured to provide said content acquired by said acquisition block with said identification information;
wherein said transmission control block transmits said content provided with said identification information by said identification information provision block to a server in which said apparatus is registered.

11. An information processing system comprising:
a user terminal; and
a server;
said user terminal including
a transmission control block configured to transmit identification information about said user terminal and information about a post destination to which content is to be transmitted,
an acquisition block configured to acquire the content, and
an identification information provision block configured to provide said content acquired by said acquisition block with said identification information;
said transmission control block transmitting said content provided with said identification information by said identification information provision block to a server in which said user terminal is registered, and
said server including
a storage block configured to store said identification information in association with the information about said post destination, and
a transmission control block configured to transmit said content which has been sent from said user terminal and which is provided with said identification information to said post destination associated with said identification information.
